(19) United States
(12) Patent Application Publication
(10) Pub. No.: US 2016/0004141 A1
(43) Pub. Date: Jan. 7, 2016

(54) CAMERA PLATFORM

(71) Applicant: SHASHIN DENKI KOGYO, Tokyo (JP)

(72) Inventor: Yutaka TERASHITA, Takaraduka-shi (JP)

(73) Assignee: SHASHIN DENKI KOGYO, Tokyo (JP)

(21) Appl. No.: 14/843,647

(22) Filed: Sep. 2, 2015

Related U.S. Application Data
(63) Continuation-in-part of application No. 29/513,606, filed on Jan. 2, 2015.

(30) Foreign Application Priority Data
Jul. 2, 2014 (JP) 2014-014575
Sep. 4, 2014 (JP) 2014-180676

(51) Int. Cl. G03B 15/06; G03B 17/56; F21V 21/14; F21V 33/00; F21V 21/06

(52) U.S. Cl. CPC G03B 15/06; F21V 33/0052; F21V 21/06; F21V 21/14; G03B 17/561; F21W 2131/40

(57) ABSTRACT

A camera platform used to mount, on a supporting body such as a tripod, a lighting fixture that illuminate a subject is structured with an attachment base fixed on the supporting body and a fixing attachment mounted on it. The attachment is such that a supporting arm that bypasses the lighting fixture and extends upwardly is disposed so as to be continued to a base on which a fixing seat for the lighting fixture is provided, the lighting fixture being on the fixing seat. A fixing hole used to fix an axis bar at the central portion of a reflector is formed at an end of the arm of the supporting arm. A positional relationship between the fixing seat for the lighting fixture, the fixing seat being mounted on the base, and the fixing hole in the supporting arm is set so that the light emitting portion of the lighting fixture is disposed so as to be adjacent to the central portion of the reflector, the central portion being attached into the fixing hole.

### TECHNICAL FIELD

The present invention relates to a camera platform that is used to mount a lighting fixture that mainly illuminates a subject in photography, TV shooting, cinematography, or the like, on a tripod or stand through a fixing attachment.

### BACKGROUND ART

Conventionally, camera platforms mounted on a supporting body such as a tripod or stand have been used a lot to mount a lighting fixture so that its depression angle or elevation angle etc. is adjustable. However, when a camera platform is used to place a lighting fixture at an appropriate illumination position with respect to a subject, together with a reflector having a concave reflection surface such as an umbrella type, a camera platform having a fixing hole is generally used, into which an axial rod at the central portion of the reflector is inserted to fix the reflector, the hole being formed in the attachment base itself, of the camera platform, that is directly mounted on a supporting body such as a tripod, particularly, at a position close to the supporting body. This is because the reflector is relatively larger and heavier than the supporting body, and to have the supporting body support the reflector in a stable manner, it can be considered that the reflector is preferably mounted so that the center of gravity of the reflector is located at a position as close as possible to the center of the supporting body.

In the structure as described above, however, a fixing seat for the lighting fixture such as a flash lamp is attached to a portion that is relatively greatly distant from the attachment base on which reflector is mounted, so the light emitting portion of the lighting fixture is positioned away from the center of the concave reflection surface of the reflector. This may make appropriate illumination difficult, may disable the lighting fixture from being fixed to the fixing seat because the lighting fixture itself comes into contact with the reflector, or may lead to a dangerous state due to heat generated by the lighting fixture. Therefore, the structure is not desirable from the viewpoint of ease of use by the user.

### SUMMARY OF INVENTION

### Technical Problem

A technical object of the present invention is to provide a camera platform, with as simple a structure as possible, that the user can easily use; when a lighting fixture that illuminates a subject in photography, TV shooting, cinematography, or the like is mounted on a supporting body such as a tripod or stand through a fixing attachment, the light emitting portion of the lighting fixture is positioned as close as possible to the center of the reflection surface of a reflector to prevent the lighting fixture from being positioned away from the center of the reflection surface, which would otherwise make appropriate illumination difficult, and also to prevent the lighting fixture itself from coming into contact with the reflector, which would otherwise make it difficult for the lighting fixture to be mounted.

### Solution to Problem

To solve the above problem, the present invention provides a first camera platform used to mount, on a supporting body, a lighting fixture that illuminates a subject, the first camera platform being characterized in that: an attachment base, which is fixed onto the supporting body, is provided; a base, on which a fixing seat for the lighting fixture is provided, is removably mounted on the attachment base, a supporting arm of bent arm type being disposed so as to be continued to the base to form a fixing attachment, the supporting arm bypassing the lighting fixture mounted on the fixing seat and extending upwardly; a fixing hole used to fix an axis bar at the central portion of a reflector having a reflection surface that focuses light on the same side as the subject side is formed at an end of the arm of the supporting arm; and a positional relationship between the fixing seat for the lighting fixture, the fixing seat being mounted on the base of the supporting arm, and the fixing hole formed in the supporting arm is set so that the light emitting portion of the lighting fixture fixed to the fixing seat is disposed so as to be adjacent to the central portion of the reflector, the central portion being attached into the fixing hole.

In a preferred embodiment of the first camera platform according to the present invention,

another fixing attachment having the same structure can be removably fixed to an upwardly extending intermediate portion of the supporting arm of the fixing attachment with the back of the supporting arm of the other fixing attachment brought into contact with the intermediate portion.

To solve the above problem, the present invention provides a second camera platform used to mount, on a supporting body, a pair of lighting fixtures that illuminate a subject, the second camera platform being characterized in that: an attachment base, which is fixed onto the supporting body, is provided; the center of a base plate of a fixing attachment is removably mounted on the attachment base, a fixing seat for the lighting fixture being disposed at each of both ends of the base plate, a supporting plate being erected upwardly from the center of the base plate; a fixing hole used to fix an axis bar at the central portion of a reflector having a reflection surface that focuses light on the same side as a subject side is formed at the upper end of the supporting plate; and a positional relationship between the fixing seats for the lighting fixtures, the fixing seats being provided at both ends of the base plate, and a fixing hole formed in the supporting plate is set so that the light emitting portions of the lighting fixtures fixed to the fixing seats are placed close to both sides of the central portion of the reflector, the central portion being attached into the fixing hole.

In preferred embodiments of the first and second camera platforms according to the present invention, it is desirable for the lighting fixture mounted on the fixing attachment to be a compact flash lamp with its light emitting portion being oriented to a subject and with its manipulation portion being oriented in a direction opposite to a direction in which the light emitting portion is oriented. It is also desirable for the attachment base to have a function that adjusts an inclination angle in a direction of illumination by the lighting fixture mounted on the fixing attachment.

### Advantageous Effects of Invention

According to the camera platform described above, it is possible to provide a camera platform, with as simple a structure as possible, that the user can easily use; when a lighting fixture that illuminates a subject in photography, TV shooting, cinematography, or the like is mounted on a supporting body such as a tripod or stand through a fixing attachment, the light emitting portion of the lighting fixture is positioned as close as possible to the center of the reflection surface of a reflector to prevent the lighting fixture from being positioned away from the center of the reflection surface, which would otherwise make appropriate illumination difficult, and also to prevent the lighting fixture itself from coming into contact with the reflector, which would otherwise make it difficult for the lighting fixture to be mounted.

### BRIEF DESCRIPTION OF DRAWINGS

FIG. 1 is a front view of a first embodiment of a camera platform according to the present invention.

FIG. 2 is a side view of the first embodiment.

FIG. 3 is a front view illustrating a different assembled aspect in the first embodiment.

FIG. 4 is a side view illustrating a state during use in the first embodiment.

FIG. 5 is a rear view illustrating a state during use in the first embodiment.

FIG. 6 is a front view of a second embodiment of the camera platform according to the present invention.

FIG. 7 is a side view of the second embodiment.

FIG. 8 is a side view illustrating a state during use in the second embodiment.

FIG. 9 is a rear view illustrating a state during use in the second embodiment.

FIG. 10 is a side view illustrating a state during use in the second embodiment with a different reflector being used.

### DESCRIPTION OF EMBODIMENTS

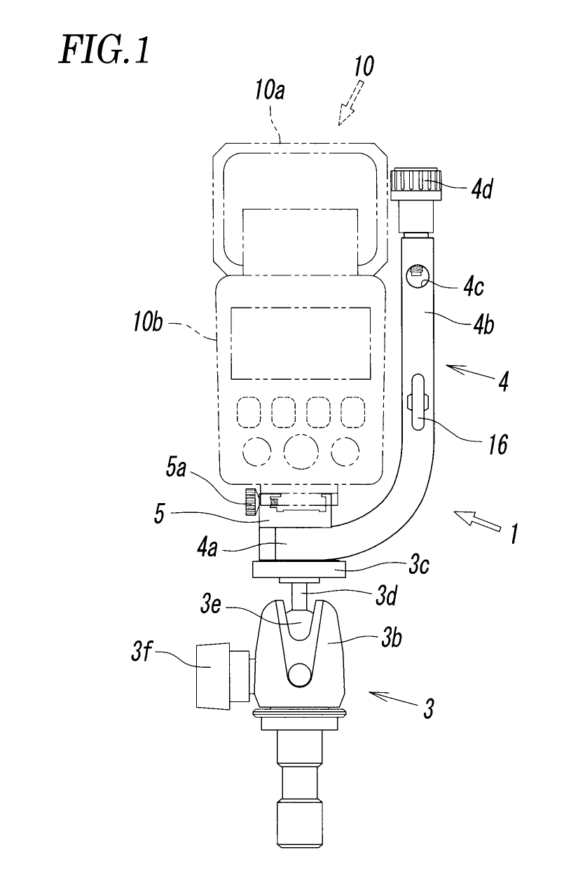

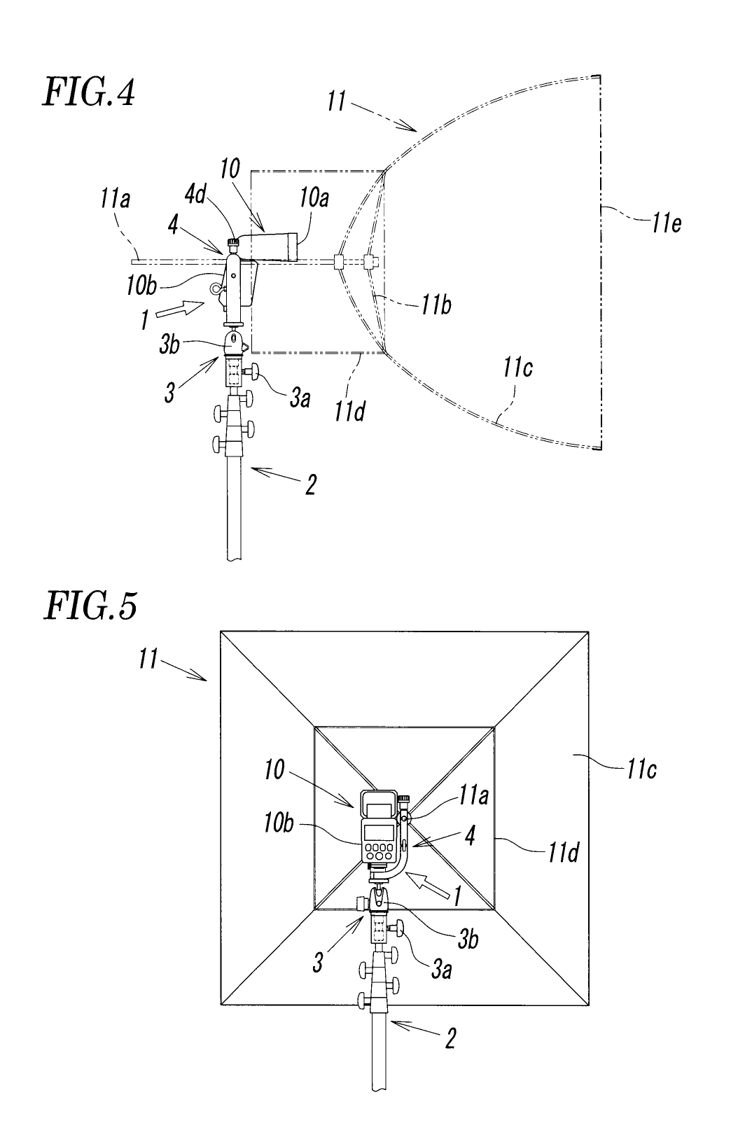

FIGS. 1 to 5 illustrate a first embodiment of a camera platform according to the present invention. This camera platform 1 is used to mount a lighting fixture 10, such as a flash lamp, that illuminates a subject in photography, TV shooting, cinematography, or the like, on a supporting body 2 such as a tripod or stand. As seen from FIGS. 4 and 5, the camera platform 1 includes an attachment base 3, which is fixed onto the supporting body 2 such as a tripod, and a fixing attachment 4, which is removably mounted on the attachment base 3, as main constituent components.

The attachment base 3 mounted on the supporting body 2 with a screw 3a has a function that adjusts the depression angle or elevation angle of a direction of illumination by the lighting fixture 10 mounted on the fixing attachment 4, which will be described later in detail, and the reflector 11. The attachment base 3 is a general-purpose fixing attachment that enables adjustment of illumination direction around the axis line of a vertical supporting axis of the supporting body 2.

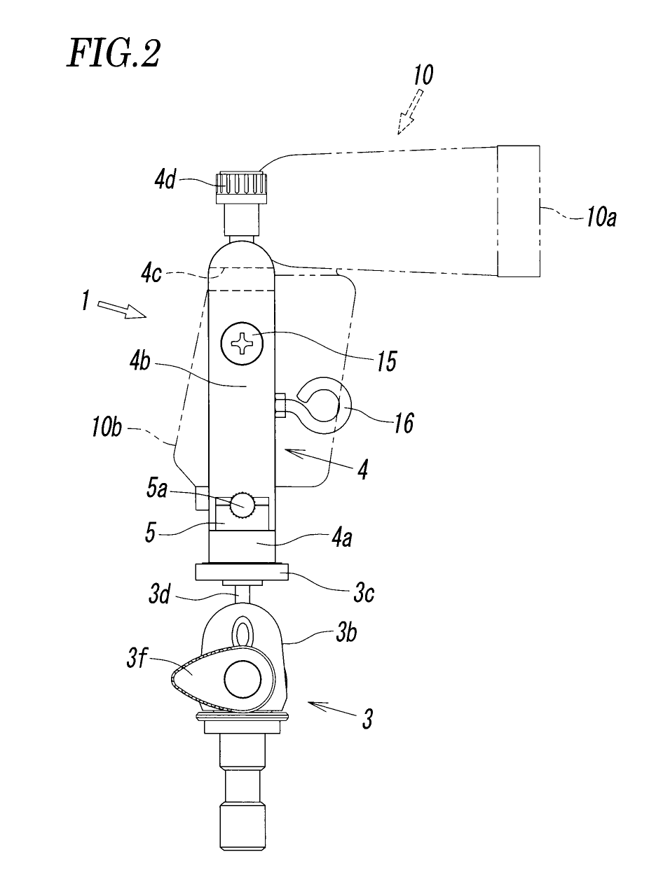

As an example, it is indicated here that a spherical titling member 3e linked with an attachment seat 3c and a short axis 3d of the fixing attachment 4 is fitted to a recess in an accepting member 3b, which is attachable to the upper end of the supporting body 2 so as to be rotatable, and the spherical titling member 3e is fixed in an arbitrary orientation with a fixing screw 3f so that the attachment seat 3c is fixed in an arbitrary orientation, as illustrated in FIGS. 1 and 2. However, the camera platform 1 is not limited to this structure; the camera platform 1 can take any structure having similar functions.

The fixing attachment 4 is removably mounted on the attachment base 3 with an attachment screw (not illustrated) that protrudes to the attachment seat 3c; a supporting arm 4b, which is a bent arm type, is disposed so as to be continued to a base 4a, which is fixed onto the attachment seat 3c, of the fixing attachment 4 in an integrated manner. A general-purpose fixing seat 5, which fixes the lighting fixture 10 with a screw 5a, is provided on the base 4a. The supporting arm 4b of bent arm type is formed so as to bypass the lighting fixture 10 mounted on the fixing seat 5 on the base 4a and extend upward at a proximity position along the lighting fixture 10. The supporting arm 4b has a fixing hole 4c, into which an axis bar 11a at the central portion of the reflector 11 is inserted, at a portion close to the end of the supporting arm 4b, the axis bar 11a inserted into the fixing hole 4c being fixed with a screw 4d. The fixing hole 4c is formed so as to be orthogonal to a portion extending toward above the supporting arm 4b of bent arm type and, at normal times, to be oriented in a direction substantially parallel to a central axis line in the direction of illumination by the lighting fixture 10 mounted on the fixing seat 5.

When a light emitting portion 10a of the lighting fixture 10 mounted on the fixing seat 5 provided on the base 4a of the supporting arm 4b is directed toward a subject, a positional relationship between the light emitting portion 10a and the fixing hole 4c formed in the supporting arm 4b is set so that, as seen from FIGS. 4 and 5, the light emitting portion 10a is disposed so as to be adjacent to the axis bar 11a at the central portion of the reflector 11, the axis bar 11a being attached into the fixing hole 4c.

If the fixing hole 4c for the reflector 11 is formed in the supporting arm 4b of bent arm type at this position, when the lighting fixture 10 is mounted on the supporting body 2 such as a tripod or stand, the light emitting portion 10a of the lighting fixture 10 can be brought as close as possible to the center of the reflection surface of the reflector 11, preventing the lighting fixture 10 from being positioned away from the center of the reflection surface, which would otherwise make appropriate illumination difficult and also preventing the lighting fixture 10 itself from coming into contact with the reflector 11, which would otherwise make it difficult for the lighting fixture 10 to be mounted.

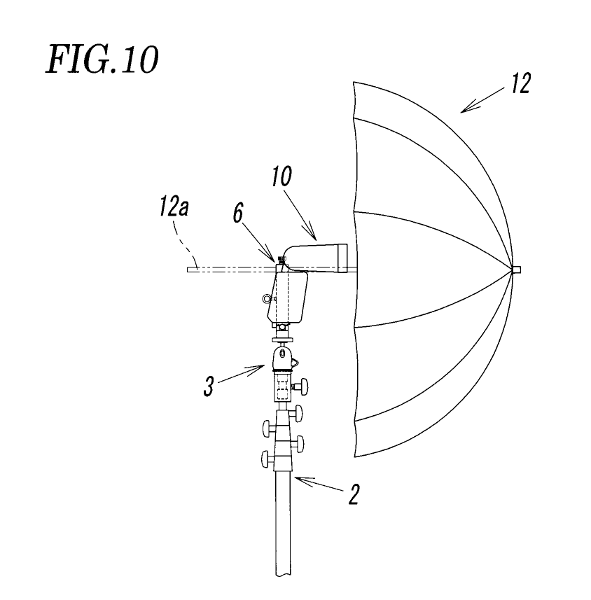

In the examples illustrated in FIGS. 4 and 5, the reflector 11 is structured so that a reflection sheet 11c is stretched so as to form a substantially pyramid shape as a whole with a supporting member 11b, in an umbrella rib shape, which has the axis bar 11a at the center, an opening is made at the top of the pyramid shape of the reflection sheet 11c, a flexible cylindrical cover 11d, which covers the lighting fixture 10, is provided so as to be continued to the periphery of the opening, and a diffuser screen 11e, which diffuses emitted light, is attached to the reflection sheet 11c on the same side as the subject. However, this structure is only an example of a usable reflector; the reflector 11 is not limited to this structure. For example, as illustrated in FIG. 10, it is also possible to use a reflector 12 of western-style type that has a reflection surface on the inner side, in which case an axis bar 12a is inserted into a fixing hole 6c formed in a fixing attachment 6 in a second embodiment, which will be described later, the fixing hole 6c being located as in the first embodiment, so that the reflection surface of the reflector 11 faces the light emitting portion 10a of the lighting fixture 10, and the axis bar 12a is fixed with a screw.

In the above embodiment, the lighting fixture 10 mounted on the fixing seat 5 provided on the fixing attachment 4 has been indicated as a compact flash lamp with the light emitting portion 10a of the lighting fixture 10 oriented to a subject and with the manipulation portion 10b of the lighting fixture 10 oriented in a direction opposite to a direction in which the light emitting portion 10a is oriented, but this is not a limitation.

The reference numeral 16 in the drawings indicates a drop-preventing eye bolt that is used to link the lighting fixture 10 and the like with a chain or the like to prevent the lighting fixture 10 from being dropped; the lighting fixture 10 is often dropped by mistake during attachment of the lighting fixture 10 to the fixing seat 5.

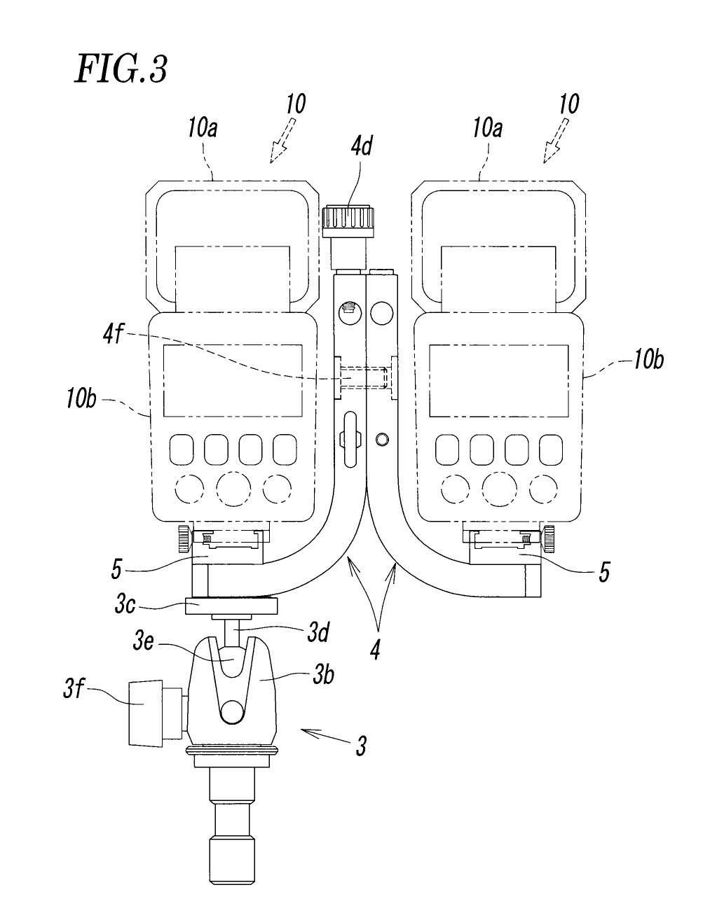

FIG. 3 indicates a variation that is used in a case in which, for example, the assembly of part of the camera platform 1 in the first embodiment described above is changed so that the camera platform 1 is adapted to more powerful illumination of a whole or part of a subject by using a pair of lighting fixtures 10. The variation is suitable to, for example, a case in which dark shadows, which are generated on part of a subject under powerful direct sunlight, are eliminated to a certain extent.

In this variation, the pair of lighting fixtures 10 are mounted on the supporting body 2. The specific structure of the variation is such that a screw hole 4e is formed in an upwardly extending intermediate portion of the supporting arm 4b of the fixing attachment 4 in the first embodiment, and the back of the supporting arm 4b and the back of the supporting arm 4b of another fixing attachment 4 having the same structure, the other fixing attachment 4 being prepared separately, are brought into contact with each other, a link screw 4f, which is prepared separately, is inserted into the two screw holes 4e to removably fix the pair of fixing attachments 4. In FIG. 3, portions common to the first embodiment are assigned the same reference characters.

As in the variation, in FIG. 3, described above, the camera platform 1 in the first embodiment can be used so that a pair of lighting fixtures 10 are mountable. If, however, the camera platform 1 is frequently used in a state in which the pair of lighting fixtures 10 are mounted, it is desirable to use a camera platform in the second embodiment, which will be described later.

If the screw hole 4e formed in the fixing attachment 4 for use as in the variation in FIG. 3 is not used, it is desirable to block the screw hole 4e with a screw 15 as illustrated in FIG. 2.

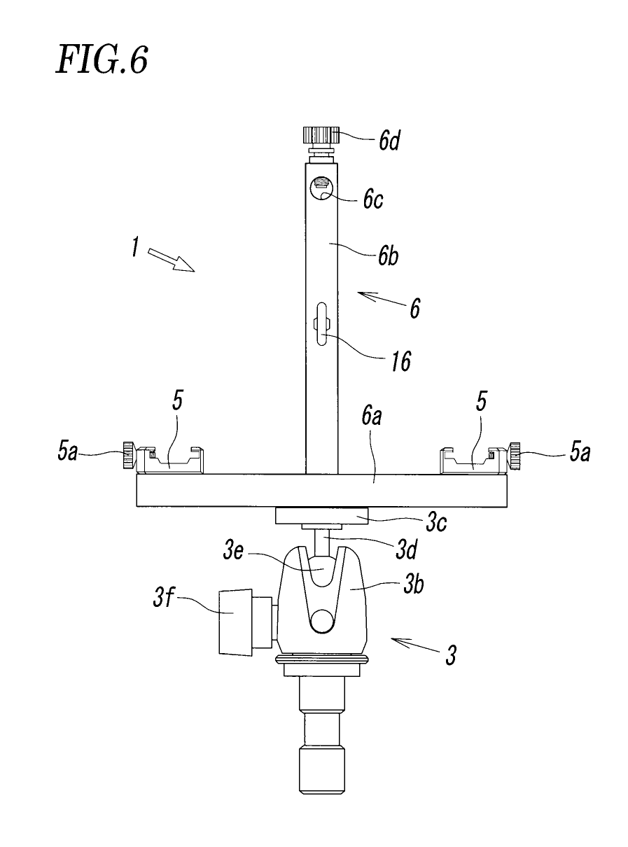

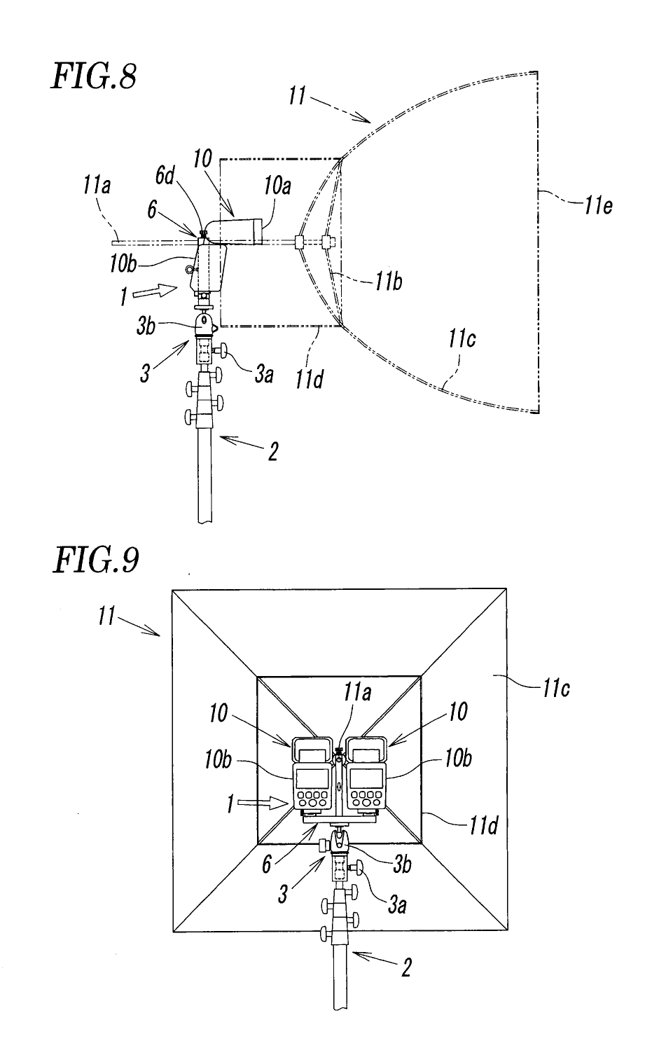

FIGS. 6 to 10 illustrate the second embodiment of the camera platform according to the present invention. In this second embodiment, its structure is obtained with a single fixing attachment 6, which will be described below, without using a pair of fixing attachments 4 described above with reference to FIG. 3.

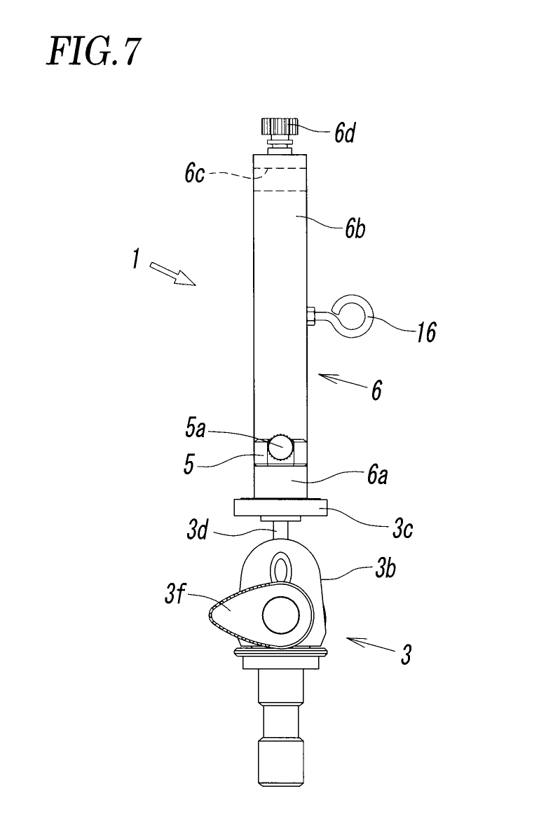

That is, the camera platform 1 in the second embodiment illustrated in FIGS. 6 and 7 is used to mount a pair of lighting fixtures 10 on the supporting body 2 so that a subject is more powerfully illuminated. The camera platform 1 includes the attachment base 3 fixed onto the supporting body 2 and the like as in the first embodiment. In the drawings, therefore, portions common to the first embodiment are assigned the same reference characters as in the first embodiment, and their descriptions will be omitted below.

A main structure, in this second embodiment, that differs from the first embodiment is the structure of the fixing attachment 6 mounted on the attachment base 3. Specifically, the fixing attachment 6 is structured so that a supporting plate 6b is erected upwardly from the center of a base plate 6a that has fixing seats 5 for the pair of lighting fixtures 10 at both ends. The attachment structure in which the center of the base plate 6a of the fixing attachment 6 is removably mounted, the structure of the fixing seats 5 provided at both ends of the base plate 6a for the pair of lighting fixtures 10, and the like do not essentially differ from the first embodiment.

At the upper end portion of the supporting plate 6b, the fixing hole 6c is formed, through which the axis bar 11a at the central portion of the reflector 11 having a reflection surface that focuses light on the subject side is inserted and in which the axis bar 11a is fixed with a fixing screw 6d.

A positional relationship between the fixing seats 5 for the lighting fixtures 10, the fixing seats 5 being provided at both ends of the base plate 6a, and the fixing hole 6c formed in the supporting plate 6b is set so that the light emitting portions 10a of the lighting fixtures 10 fixed to the fixing seats 5 are placed close to both sides of the central portion of the reflector 11, the central portion being attached into the fixing hole 6c.

As described above in detail, according the camera platform 1 of the present invention, when the lighting fixture 10 is mounted on the supporting body 2 such as a tripod or stand through the fixing attachment 4 or 6, the light emitting portion 10a of the lighting fixture 10 can be positioned as close as possible to the center of a reflector, so it is prevented that the lighting fixture from being positioned away from the center of the reflector, which would otherwise make appropriate illumination difficult and that the lighting fixture itself comes into contact with the reflector, which would otherwise make it difficult for the lighting fixture to be mounted. As a result, it is possible to provide a camera platform, with as simple a structure as possible, that the user can easily use.

### REFERENCE SIGNS LIST

1: camera platform
2: supporting body
3: attachment base
4, 6: fixing attachment
4a: base
4b: supporting arm
4c: fixing hole
5: fixing seat
10: lighting fixture
11: reflector
11a: axis bar

1. A camera platform used to mount, on a supporting body, a lighting fixture that illuminates a subject, wherein:
an attachment base, which is fixed onto the supporting body, is provided;
a base, on which a fixing seat for the lighting fixture is provided, is removably mounted on the attachment base, a supporting arm of bent arm type being disposed so as to be continued to the base to form a fixing attachment, the supporting arm bypassing the lighting fixture mounted on the fixing seat and extending upwardly;
a fixing hole used to fix an axis bar at a central portion of a reflector having a reflection surface that focuses light on the same side as a subject side is formed at an end of an arm of the supporting arm; and
a positional relationship between the fixing seat for the lighting fixture, the fixing seat being mounted on the base of the supporting arm, and the fixing hole formed in the supporting arm is set so that a light emitting portion of the lighting fixture fixed to the fixing seat is disposed so as to be adjacent to the central portion of the reflector, the central portion being attached into the fixing hole.

2. The camera platform according to claim 1, wherein another fixing attachment having the same structure is removably fixed to an upwardly extending intermediate portion of the supporting arm of the fixing attachment with a back of the supporting arm of the another fixing attachment brought into contact with the intermediate portion.

3. A camera platform used to mount, on a supporting body, a pair of lighting fixtures that illuminate a subject, wherein:
an attachment base, which is fixed onto the supporting body, is provided;
a center of a base plate of a fixing attachment is removably mounted on the attachment base, a fixing seat for the lighting fixture being disposed at each of both ends, a supporting plate being erected upwardly from the center of the base plate;
a fixing hole used to fix an axis bar at a central portion of a reflector having a reflection surface that focuses light on the same side as a subject side is formed at an upper end of the supporting plate; and
a positional relationship between the fixing seats for the lighting fixtures, the fixing seats being provided at the both ends of the base plate, and a fixing hole formed in the supporting plate is set so that light emitting portions of the lighting fixtures fixed to the fixing seats are placed close to both sides of the central portion of the reflector, the central portion being attached into the fixing hole.

4. The camera platform according to claim 1, wherein the lighting fixture mounted on the fixing attachment is a compact flash lamp with a light emitting portion of the lighting fixture being oriented to a subject and with a manipulation portion of the lighting fixture being oriented in a direction opposite to a direction in which the light emitting portion is oriented.

5. The camera platform according to claim 1, wherein the attachment base has a function that adjusts an inclination angle in a direction of illumination by the lighting fixture mounted on the fixing attachment.

6. The camera platform according to claim 3, wherein the lighting fixture mounted on the fixing attachment is a compact flash lamp with a light emitting portion of the lighting fixture being oriented to a subject and with a manipulation portion of the lighting fixture being oriented in a direction opposite to a direction in which the light emitting portion is oriented.

7. The camera platform according to claim 3, wherein the attachment base has a function that adjusts an inclination angle in a direction of illumination by the lighting fixture mounted on the fixing attachment.
